(19) United States
(12) Patent Application Publication
(10) Pub. No.: US 2026/0203340 A1
(43) Pub. Date: Jul. 16, 2026

(54) KNOWLEDGE DOMAIN PARITY MECHANISM FOR AUTOMATED FUNCTIONAL TESTING OF NON-DETERMINISTIC SYSTEMS

(71) Applicant: Microsoft Technology Licensing, LLC, Redmond, WA (US)

(72) Inventors: Hadas BITRAN, Ramat Hasharon (IL); Uri ZONENS, Tel Aviv (IL); Rachel WITIES, Givat Shmuel (IL)

(21) Appl. No.: 19/020,486

(22) Filed: Jan. 14, 2025

(51) Int. Cl. G06F 16/36; G06F 16/353

(52) U.S. Cl. CPC G06F 16/367; G06F 16/353

(57) ABSTRACT

A model output evaluator may, for each ground truth text of ground truth texts, link response entities of a language model output text and ground truth entities of the ground truth text to corresponding ontology entities of an ontology that includes the set of ontology entities and edges connecting the ontology entities. The evaluator may, for each ground truth text, determine a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities. The evaluator may classify the output text of the language model based on at least one of the ground truth text scores satisfying a classification condition.

### BACKGROUND

As generative artificial intelligence (AI) technologies continue to improve and gain popularity, AI language models are increasingly relied upon for content generation tasks, such as question answering. However, because the output of AI models is non-deterministic even when provided the same input multiple times, it is challenging to evaluate the quality of such models.

### SUMMARY

In some aspects, the techniques described herein relate to a method of classifying an output text of a language model corresponding to a knowledge domain, including: for each ground truth text of ground truth texts corresponding to the knowledge domain, linking response entities of the output text and ground truth entities of the ground truth text to corresponding ontology entities of a set of ontology entities of an ontology corresponding to the knowledge domain, wherein the ontology includes the set of ontology entities and edges connecting the ontology entities; for each ground truth text of the ground truth texts, determining a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and classifying the output text of the language model as a predefined category based on at least one ground truth text score of the ground truth text scores satisfying a classification condition.

In some aspects, the techniques described herein relate to a system for classifying an output text of a language model corresponding to a knowledge domain, including: one or more hardware processors; a memory; a entity-ontology linker storable in the memory, executable by the one or more hardware processors, and configured to perform operations including linking, for each ground truth text of ground truth texts corresponding to the knowledge domain, response entities of the output text and ground truth entities of the ground truth text to corresponding ontology entities of a set of ontology entities of an ontology corresponding to the knowledge domain, wherein the ontology includes the set of ontology entities and edges connecting the ontology entities; a ground truth text scorer storable in the memory, executable by the one or more hardware processors and configured to perform operations including determining, for each ground truth text of the ground truth texts, a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and an output text classifier storable in the memory, executable by the one or more hardware processors, and configured to perform operations including classifying the output text of the language model as a predefined category based on at least one ground truth text score of the ground truth text scores satisfying a classification condition.

In some aspects, the techniques described herein relate to one or more tangible processor-readable storage media embodied with instructions for executing on one or more processors and circuits of a computing device a process for classifying an output text of a language model corresponding to a knowledge domain, the process including: for each ground truth text of ground truth texts corresponding to the knowledge domain, linking response entities of the output text and ground truth entities of the ground truth text to corresponding ontology entities of a set of ontology entities of an ontology corresponding to the knowledge domain, wherein the ontology includes the set of ontology entities and edges connecting the ontology entities; for each ground truth text of the ground truth texts, determining a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and classifying the output text of the language model as a predefined category based on a least one of the ground truth text scores satisfying a classification condition.

Other implementations are also described and recited herein.

### BRIEF DESCRIPTIONS OF THE DRAWINGS

FIG. 1 illustrates an example computing environment for evaluating, by a model output evaluator, a language model output text of a language model using a ground truth text and an ontology.

FIG. 2 illustrates an example computing environment for generating, using a model output evaluator, an ontology-entity mapping for entities of a language model output text and of multiple ground truth texts for use in evaluating the language model output text in view of the multiple ground truth texts.

FIG. 3 illustrates an example computing environment for determining, by a model output evaluator for each ground truth text of multiple ground truth texts using an ontology-entity mapping, a ground truth text score based on traversal distances between corresponding linked entities of a language model output text and of multiple ground truth texts.

FIG. 4 illustrates an example computing environment for determining, by a model output evaluator, a classification of an output text of a language model based on ground truth text scores determined for multiple ground truth texts.

FIG. 5 illustrates a portion of an example ontology.

FIG. 6 illustrates an ontology-entity mapping, including linked response entities of a language model output text and linked ground truth entities of a ground truth text mapped to ontology entities of an ontology.

FIG. 7 illustrates a process for determining a traversal distance for a linked to response entity of a language model output text using an ontology-entity mapping for use in determining a ground truth text score.

FIG. 8 illustrates an example of minimal traversal distances calculated for three response entities of a language model output text using an ontology-entity mapping for use in determining a ground truth text score.

FIG. 9 depicts example operations for classifying an output text of a language model corresponding to a knowledge domain.

FIG. 10 illustrates an example computing device for use in implementing the described technology.

### DETAILED DESCRIPTIONS

A significant unresolved issue is the difficulty of evaluating the quality of AI language models, including AI language models in specialized knowledge domains (e.g., clinical, legal, etc.). AI language models are non-deterministic, meaning the outputs may vary even when provided with the same input. For example, when given the same input data, an AI language model may provide the same substantive answer phrased differently in separate outputs. For example, the first output of the model may include the term “high blood pressure,” while another output includes the term “hypertension,” a term of equivalent meaning. In another example, the AI language model may provide substantively different answers (e.g., different treatment approaches, different legal approaches) given the same input data, but that are both valid answers in the knowledge domain (e.g., medical knowledge, legal knowledge) of the AI language model. Accordingly, automated functional testing of AI language models is a complex and challenging. Automated functional testing methodologies that rely on textual comparison of an output text of an AI language model against a text of a ground truth reference are not adequate for automated functional testing of these models because such approaches fail to account for these style/language variations within ground truth references and fail to account for the existence of a variety of valid but divergent approaches/opinions within ground truth references of the knowledge domain.

The technology disclosed herein addresses the inadequacies of automated functional testing of an AI language model by linking (e.g., mapping) entities of the AI language model output and of multiple ground truth references to entities in an ontology of the same knowledge domain as the AI language model. Using this ontology-based linking, the described technology also involves scoring each of the ground truth references based on traversal distances (e.g., the number of edges traversed) within the ontology between each of the linked entities of the AI language model output and each of the corresponding linked entities of the ground truth reference. The described technology involves determining if at least one ground truth reference supports the AI language model output based on the score(s) of the at least one ground truth reference meeting a specified condition. Accordingly, certain implementations of the disclosed technology use the ontology-based entity mapping of AI language model output and ground truth references to identify whether at least one ground truth reference adequately supports the AI language model output.

For example, entities (e.g., a topic, a diagnosis, a condition, a symptom) are concepts listed within an ontology. Entities may be detected within AI language model output and ground truth references by using a named entity recognition (NER) algorithm.

An ontology is a formal data structure representing knowledge about a specific domain (e.g., medical diseases). It organizes entities (e.g., concepts) and properties of the entities (e.g., attributes, hierarchical relationships) in a structured way. For example, the ontology may use a graph structure where nodes represent entities and edges represent properties. Properties can include hierarchical relationships. For example, classes represent categories or types of objects in the domain and define a set of entities with common characteristics. An individual, also known as an instance, represents a single, concrete entity that belongs to a class. For example, a class (e.g., category) entity node may include one or multiple individual (e.g., instance) entity nodes within the class. In this example, the class may be an instance entity node of a higher class, and one or more instance entity nodes may also be a class entity node with further instance nodes within the class. Properties describe attributes of classes or individuals (e.g., data properties) and define relationships between them (e.g., object properties). For example, data properties specify characteristics or attributes of a class or individual and are associated with specific data values (e.g., numerical, textual, etc.). Object properties define relationships between individuals. Ontologies may be structured hierarchically, where classes are organized into superclass-subclass (e.g., parent-child) relationships. The ontology may include logical statements or rules (e.g., axioms) that define how classes, individuals, and properties interact. For example, the ontology may require that every instance entity of the disease class entity have a relationship to at least one instance of the symptoms class.

Accordingly, certain implementations of the disclosed technology use the ontology-based entity mapping of AI language model output and ground truth references to identify whether at least one ground truth reference adequately supports the AI language model output. Specifically, the disclosed technology involves scoring each of multiple ground truth references based on traversal distances within the ontology (e.g., number of edges traversed) between entities of the language model output (e.g., response entities) and corresponding entities of the ground truth reference (e.g., ground truth entities). A category (e.g., one of a set of predefined categories, such as pass or fail) is determined for the language model output based on identifying at least one ground truth reference having a score that meets a predefined condition (e.g., the average traversal distance is less than or equal to 2, or other predefined condition). Accordingly, the disclosed technology can perform automated functional testing of an AI language model by evaluating the similarity of its output to multiple ground truth texts via ontology-entity mapping, which provides a more accurate evaluation of the AI language model than techniques that do not use the ontology-based entity mapping of the described technology and that merely compare the similarity of the output text to a ground truth reference text.

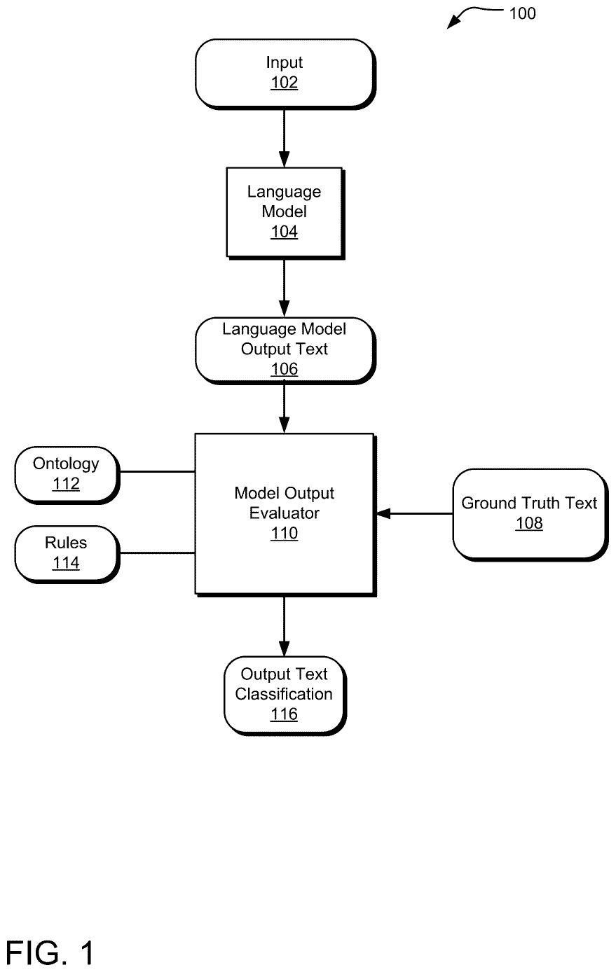

FIG. 1 illustrates an example computing environment 100 for evaluating, by a model output evaluator 110, a language model output text 106 of a language model 104 using a ground truth text 108 and an ontology 112. The example computing environment 100 includes a language model 104 and a model output evaluator 110.

The language model 104, in some implementations, is trained to process and respond to an input 102 (e.g., a natural language query) and to provide language model output text 106 that is specific to a knowledge domain and that is responsive to the input 102. For example, the knowledge domain is medical diagnoses, law, rules of a specific organization, or other knowledge domain. Examples of language models include large language models (LLMs), transformer-based models (e.g., a generative pre-trained transformer (GPT) model, an Open Pretrained Transformer (OPT) model, or Bioscience Large Open-science Open-access Multilingual (BLOOM) model), as well as seq2seq models, long short-term memory networks (LSTM), and recurrent neural networks (RNNs).

As depicted in FIG. 1, responsive to receiving the input 102, the language model 104 generates the language model output text 106. For example, the input 102 may be a natural language query requesting a medical diagnosis for a list of symptoms. An example of the input 102 is a text string reading, “I have a fever of 102.5 degrees Fahrenheit, chills, and muscle aches. Do I have a virus?” and an example language model output text 106 generated responsive to the input 102 is a medical diagnosis and other explanatory data (e.g., a treatment recommendation).

The model output evaluator 110 generates, for the language model output text 106, an output text classification 116 based on traversal distances within an ontology 112 between entities detected in the language model output text 106 and corresponding entities detected in the ground truth text 108 used to evaluate the language model output text 106.

The ontology 112 is a formal data structure that represents knowledge about a specific knowledge domain (e.g., medical diseases) that corresponds to the knowledge domain of the language model 104. The ontology 112 organizes entities (e.g., concepts) and properties of the entities (e.g., attributes, hierarchical relationships) in a structured way. For example, the ontology 112 may use a graph structure where nodes represent entities and edges represent properties. However, data structures (e.g., tables) other than a graph structure may be used to represent entities and properties. Properties may include hierarchical relationships. For example, class entities represent categories or types of objects in the knowledge domain and define a set of entities with common characteristics. An individual entity, also known as an instance, represents a single, concrete entity that belongs to a class. For example, a class (e.g., category) entity node may include one or multiple individual (e.g., instance) entity nodes within the class. In this example, the class entity may itself be an instance entity node of a higher class, and one or more of the instance entity nodes may also be a class entity node with further instance nodes within the class. Properties describe attributes (e.g., data properties) of class entities or individual entities and define relationships between them (e.g., object properties). For example, data properties specify characteristics or attributes of a class entity or individual entity and are associated with specific data values (e.g., numerical, textual, etc.). Object properties define relationships between individual entities. The ontology 112 may be structured hierarchically, where class entities are organized into superclass-subclass (e.g., parent-child) relationships. The ontology 112 may include logical statements or axioms that define how class entities, individual entities, and properties interact. For example, the ontology 112 may correspond to a medical diagnosis knowledge domain and require that every instance entity of a disease class entity have a relationship to at least one instance entity of the symptoms class entity.

The model output evaluator 110 identifies entities in the language model output text 106 (response entities) and identifies entities in the ground truth text 108 (ground truth entities). For example, the model output evaluator 110 may apply a named entity recognition (NER) algorithm to the language model output text 106 and to the ground truth text 108 to determine the response entities and the ground truth entities, respectively. The model output evaluator 110 links (e.g., maps) the response entities and the ground truth entities to corresponding entities of the ontology 112 (ontology entities). The model output evaluator 110 determines a corresponding position within the ontology 112 for each of the linked response entities and for each of the linked ground truth entities. Sometimes, one or more detected response entities are not linked to the ontology 112 when corresponding ontology entities do not exist for such response entities. In some implementations, detected response entities that do not correspond to ontology entities (e.g., unmatched entities) are ignored. In some implementations, detected response entities may be matched to ontology entities using a matching algorithm, for example, assigning a matching score to an ontology entity for a detected response entity using a lemmatization and string match approach and then linking the detected response entity to the ontology entity based on the matching score (e.g., responsive to determining that the matching score is greater than a threshold matching score).

The model output evaluator 110 determines, for each linked response entity of the linked response entities, a traversal distance to one or more linked ground truth entities of the linked ground truth entities and selects a traversal distance of the determined traversal distances that satisfies a condition. For example, the condition is that the traversal distance is the minimum traversal distance of the determined traversal distances, within a standard deviation of the minimum traversal distance, or other specified condition. For example, the selected traversal distance for the linked response entity is the traversal distance across the ontology 112 between the linked response entity and a linked ground truth entity having a shortest traversal distance. Based on the selected traversal distances (e.g., selected traversal distances within the ontology 112 determined for each linked response entity and a classification condition, the model output evaluator 110 assigns the output text classification 116 to the language model output text 106. In some implementations, the model output evaluator 110 determines a ground truth text score based on the selected traversal distances (e.g., based on an average of the selected traversal distances, a mode of the selected traversal distances, or other statistic determined from the selected traversal distances) and assigns the output text classification 116 based on comparing the ground truth text score to a threshold ground truth text score. For example, the classification condition may specify a “pass” classification if the ground truth text score, determined from the selected traversal distances (e.g., average of selected traversal distances, etc.), is less than a threshold ground truth text score and a “fail” classification if the average traversal distance is equal to or greater than the ground truth text score. This classification condition is one example, and other classification conditions may be used.

In some implementations, edges between entities in the ontology 112 have corresponding weights, and the model output evaluator 110 determines the traversal distances by multiplying each edge by its corresponding weight. For example, specific edge types (e.g., an “is a symptom of” edge) may have a first weight (e.g., a weight of 1.0), while other edge types (e.g., an “is a related illness” edge) may have a second weight (e.g., a weight of 0.6). For example, the traversal path between entity A and entity B includes two edges with a weight of 0.6 and one edge with a weight of 1.0, and the traversal distance is (2×0.6)+ (1×1.0)=2.2.

In some implementations, the model output evaluator 110 determines the traversal distances in accordance with one or more rules 114 accessible to the model output evaluator 110. The rules 114 constrain which linked ground truth entities of the ground truth text are used for calculating traversal distances from a linked response entity. In other words, the model output evaluator 110 determines a traversal distance to each linked ground truth entity not excluded by the rules 114. [Inventors: is my understanding correct here that we calculate a traversal distance to all possible linked ground truth entities of the ground truth text that comply with the rules 114 (assertion strictness, maximum graph distance, traversable/non-traversable edge types)?] The model output evaluator 110 selects, from the calculated traversal distances computed for the linked response entity, a selected traversal distance for the linked response entity based on criteria. For example, the criteria may be a minimum traversal distance of the calculated traversal distances. For example if linked response entity corresponds to the ontology entity “pneumonitis,” and the ground truth linked entities included pleural effusion (e.g., edge distance of 2 from “pneumonitis”) and viral pneumonitis (e.g., edge distance of 1 from pneumonitis) and pneumothorax (edge distance of 3 from “pneumonitis”), the selected traversal distance for the response entity is “1” because the traversal distance between pneumonitis and viral pneumonitis is the minimal traversal distance of the three computed traversal distances. The model output evaluator 110 likewise determines, for each of the remaining linked response entities, traversal distances and selects, from the computed traversal distances, a selected traversal distance to yield a set of selected traversal distances for the ground truth text.

The one or more rules 114 may be stored in a memory accessible to the model output evaluator 110. An operator of the model output evaluator 110 may configure the rules 114. In some implementations, the rules 114 may specify an assertion strictness, which determines a tolerance for mapping the linked response entity to the linked ground truth entity for purposes of calculating a traversal distance. For example, in a strict assertion strictness, a traversal distance between a “do not inject insulin” linked response entity and an “inject insulin” linked ground truth entity (e.g., a positive assertion to a negative assertion) is not calculated, and a traversal distance between a “physical therapy required” linked response entity and a “physical therapy recommended” linked ground truth entity (e.g., a strong positive assertion to a slightly positive assertion) is not calculated. However, in a moderate assertion strictness, which allows linked entities of varying degrees of positive assertion or varying degrees of negative assertion to be matched, the traversal distance between a “physical therapy required” linked response entity and a “physical therapy recommended” linked ground truth entity (e.g., a strong positive assertion to a slightly positive assertion) is calculated. The assertion strictness defined in the rules 114 may be configurable by an operator of the model output evaluator 110. Increasing the assertion strictness may reduce the potential number of corroborating ground truth texts and may also fail to account for a variety of styles used in the knowledge domain (e.g., some doctors prefer to provide a “possible” diagnosis while others may determine a “probable” diagnosis when given the same set of facts.). Likewise, decreasing the assertion strictness may increase a tolerance for various styles used in the knowledge domain and the potential number of corroborating ground truth texts.

In some implementations, the rules 114 may specify a maximum traversal distance. In some implementations, the maximum traversal distance may specify the maximum number of edges traversed between the linked response entity and a linked ground truth entity. The maximum traversal distance may be a maximum weighted traversal distance determined by adding weights corresponding to each traversed edge between the linked response entity and the linked ground truth entity. The maximum traversal distance defined in the rules 114 may be configurable by an operator of the model output evaluator 110. Increasing the maximum traversal distance may increase the potential number of corroborating ground truth texts. Likewise, decreasing the maximum traversal distance may decrease the potential number of corroborating ground truth texts.

In some implementations, the rules 114 may specify traversable and non-traversable edge types and constrain the traversal distance calculation to calculate a minimum traversal distance over traversable edge types only. For example, the traversable edge types may include an “is a symptom of” edge types, and the non-traversable edge types may include “is a cure of” edge types. An operator of the model output evaluator 110 may configure the rules 114 to define traversable and non-traversable edge types.

In some implementations, the model output evaluator 110 calculates a ground truth text score for the ground truth text 108 based on the determined traversal distances for each of the linked response entities and a classification condition. For example, the classification condition is a threshold ground truth text score, and the model output evaluator 110 assigns the output text classification 116 to the language model output text 106 based on a relationship of comparison (e.g., is greater than, is greater than or equal to, is less than, is less than or equal to, or other specified relationship of comparison) of the ground truth text score to the threshold ground truth text score. For example, the model output evaluator 110 may assign a “pass” output text classification 116 to the language model if the ground truth text score is less than or equal to the threshold ground truth text score, which indicates that the language model output text 106 is sufficiently supported by (e.g., corroborated by) the ground truth text 108 and that the language model 104, accordingly, may be reliable. In this example, the model output evaluator 110 may assign a “fail” output text classification 116 to the language model if the ground truth text score is greater than the threshold ground truth text score, which indicates that the language model output text 106 is not sufficiently supported by (e.g., corroborated by) the ground truth text 108 and that the language model 104, accordingly, may not be reliable.

In some implementations, the model output evaluator 110 considers multiple ground truth texts for determining the output text classification 116 for the language model output text 106. In these implementations, the model output evaluator determines a ground truth text score for each of the ground truth texts based on traversal distances (e.g., minimum traversal distances) within the ontology 112 between each of the linked response entities to the linked ground truth entities of the ground truth text. For example, the traversal distances are determined for each of the ground truth texts in accordance with the rules 114 as described herein. The model output evaluator 110 determines an output text classification 116 based on the ground truth text scores (e.g., one ground truth text score for each ground truth text) corresponding to the multiple ground truth texts. For example, the model output evaluator 110 assigns the output text classification 116 to the language model output text 106 based on a relationship of comparison (e.g., is greater than, is greater than or equal to, is less than, is less than or equal to, or other specified relationship of comparison) of at least one of the ground truth text scores to the threshold ground truth text score. For example, the model output evaluator 110 may assign a “pass” output text classification 116 to the language model if at least one of the ground truth text scores is less than or equal to the threshold ground truth text score. For example, the “pass” output text classification 116 indicates that the language model output text 106 is sufficiently supported by (e.g., corroborated by) the at least one of the multiple ground truth texts corresponding to the at least one of the ground truth text scores and that the language model 104, accordingly, may be reliable. The model output evaluator 110 may assign a “fail” output text classification 116 to the language model if none of the ground truth text scores exceed the threshold ground truth text score. The “fail” output text classification 116 indicates that the language model output text 106 is not sufficiently supported by (e.g., corroborated by) any of the multiple ground truth texts and that the language model 104 may not be reliable.

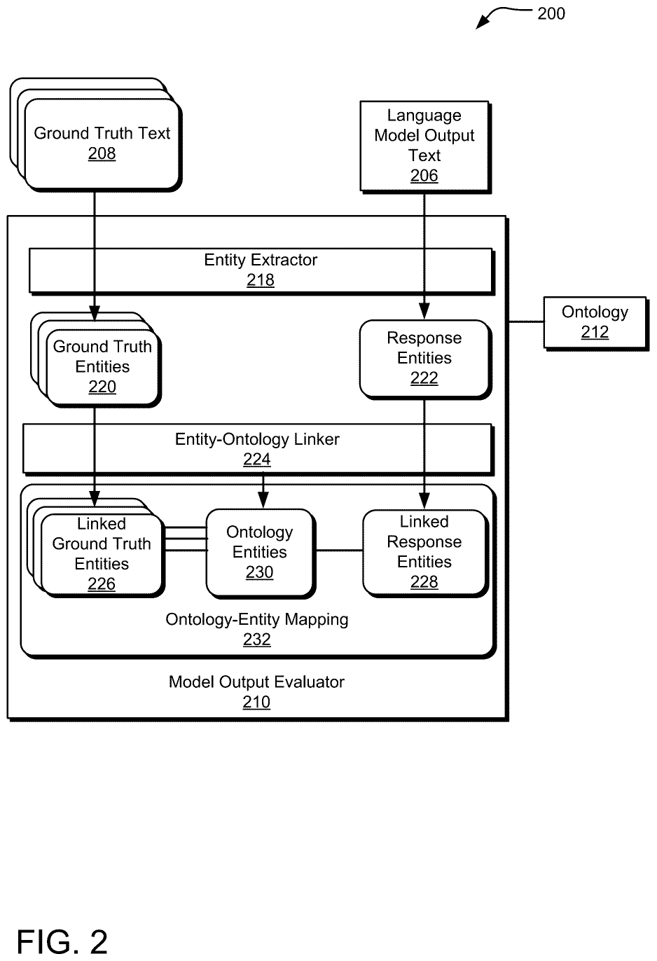

FIG. 2 illustrates an example computing environment 200 for generating, using a model output evaluator 210, an ontology-entity mapping 232 for entities of a language model output text 206 and of multiple ground truth texts for use in evaluating the language model output text 206 in view of the multiple ground truth texts. The example computing environment 200 includes a model output evaluator 210. The model output evaluator 210 generates an ontology-entity mapping 232 based on multiple ground truth texts (e.g., ground truth text 208) and the language model output text 206. In some implementations, the model output evaluator 210 includes an entity extractor 218 and an entity-ontology linker 224.

The entity extractor 218 extracts or otherwise identifies ground truth entities (e.g., ground truth entities 220) in each of the multiple ground truth texts (e.g. ground truth text 208) and extracts or otherwise identifies response entities 222 in the language model output text 206. The entity extractor 218 may apply a named entity recognition (NER) algorithm to the language model output text 206 and to the multiple ground truth texts (e.g., the ground truth text 208) to determine the response entities 222 and the ground truth entities of each of the ground truth texts, respectively.

The entity-ontology linker 224 generates an ontology-entity mapping 232 by linking (e.g., mapping) the response entities 222 to corresponding ontology entities 230 of the ontology 212 and, for each of the multiple ground truth texts (e.g., ground truth text 208), linking (e.g., mapping) the ground truth entities (e.g., ground truth entities 220) of the ground truth text to corresponding ontology entities 230 of the ontology 212. Linking the entities may include identifying entity nodes of the ontology 212 that correspond to the identified entities in the ground truth text and in the language model output text 206. Ontology entities 230 may, in some applications, be identified by one or more codes (e.g., unified medical language system “UMLS” codes) or other identifier. Accordingly, the ontology-entity mapping includes linked ground truth entities (e.g., linked ground truth entities 226) corresponding to each of the multiple ground truth texts (e.g., ground truth text 208) and linked response entities 228 corresponding to the language model output text 206. As depicted in FIG. 2 with lines, the linked ground truth entities identified in each of the multiple ground truth texts (e.g., linked ground truth entities 226) are linked to their corresponding ontology entities 230 of the ontology 212 and the linked response entities 228 are linked to their corresponding ontology entities 230 of the ontology 212. Accordingly, the ontology-entity mapping maps each of the linked ground truth entities and the linked response entities 228 within the ontology 212 so that traversal distances within the ontology 212 may be determined between linked response entities 228 and linked ground truth entities (e.g., linked ground truth entities 226).

In some implementations, the ontology-entity mapping 232 generated by the model output evaluator 210, may be used by the model output evaluator 210 to determine, for each of the multiple ground truth texts (e.g., ground truth text 208), traversal distances within the ontology 212 between linked response entities 228 to linked ground truth entities 226 of the ground truth text.

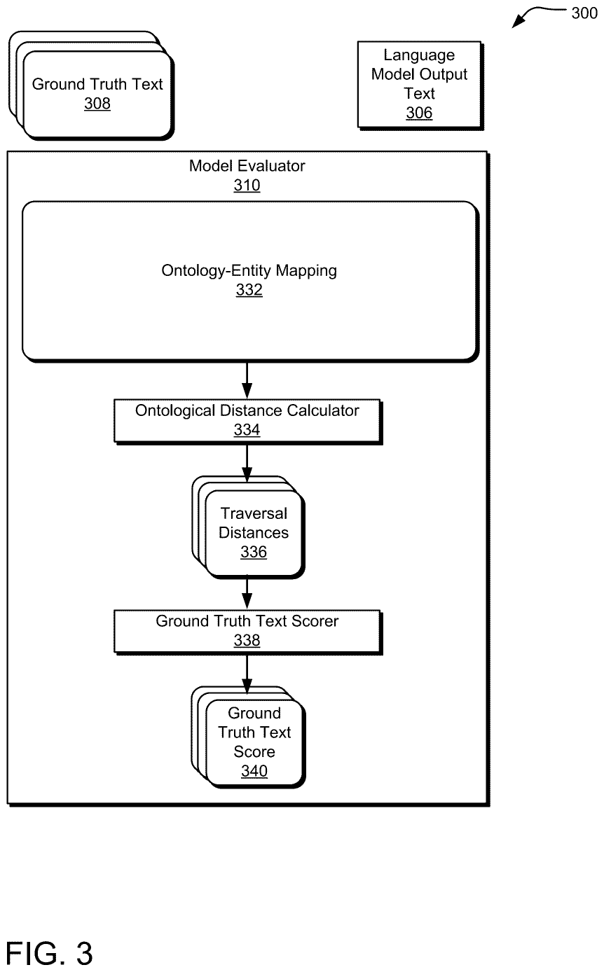

FIG. 3 illustrates an example computing environment 300 for determining, by a model output evaluator 310 for each ground truth text of multiple ground truth texts using an ontology-entity mapping 332, a ground truth text score based on traversal distances between corresponding linked entities of a language model output text 306 and of multiple ground truth texts. The example computing environment 300 includes a model output evaluator 310. The model output evaluator 310 includes an ontological distance calculator 334 and a ground truth text scorer 338.

The ontological distance calculator 334 uses the ontology-entity mapping 332 to determine, for each of the multiple ground truth texts (e.g., ground truth text 308), a corresponding set of traversal distances (e.g., traversal distances 336) within the ontology between linked response entities of the language model output text 306 to linked ground truth entities of the ground truth text. The ontology-entity mapping 332 includes linked ground truth entities corresponding to each of the multiple ground truth texts (e.g., ground truth text 308) and linked response entities corresponding to a language model output text. For example, a linked entity (e.g., linked ground truth entity or a linked response entity) is an entity that is mapped to a corresponding entity in an ontology, for example, an ontology of a same knowledge domain as a language model that generated the language model output text 306. Accordingly, the ontology-entity mapping 332 enables traversal distances within the ontology to be determined between linked response entities and linked ground truth entities of each ground truth text of the multiple ground truth texts. For example, traversing the ontology between a linked response entity and a linked ground truth entity means traversing the ontology (e.g., traversing across edges and/or nodes) between a first ontology entity corresponding to the linked response entity and a second ontology entity corresponding to the linked ground truth entity.

The ontological distance calculator 334 determines, for each ground truth text and using the ontology-entity mapping 332, a set of traversal distances (e.g., traversal distances 336). The set of traversal distances include, for each of the linked response entities of the language model output text 306, traversal distances to one or more linked ground truth entities of the ground truth text. For example, for each of the linked response entities, the ontological distance calculator 334 determines candidate traversal distances between the linked response entity and each of the one or more linked ground truth entities, in accordance with rules (e.g., specifying one or more of an assertion strictness, a maximum graph distance, or traversable edge types) and selects, from the candidate traversal distances, a traversal distance that satisfies a condition (e.g., the condition specifies that the traversal distance is the minimum traversal distance of the candidate traversal distances) as the traversal distance corresponding to the response entity to include in the set of selected traversal distances for the ground truth text. Accordingly, in some implementations, the set of selected traversal distances for the ground truth text includes, for each response entity, a minimum traversal distance. The ontological distance calculator 334 determines a corresponding set of selected traversal distances for each of the multiple ground truth texts.

For example, the ontological distance calculator 334 may calculate a traversal distance between a linked response entity and a linked ground truth entity as follows:

$$D = {\sum }_{j = 1}^{m} {w}_{j} , \qquad ( 1 )$$

where D denotes a weighted traversal distance between the linked response entity and the linked ground truth entity, where wⱼ denotes the weight the jth edge of m traversed edges between the response entity and the ground truth entity. In some implementations, a weighted traversal distance is not utilized and, instead, a simple traversal distance (e.g., a number of the traversed edges) is calculated. As described in implementations herein, the traversal distance is calculated only for a traversal paths that satisfy the one or more rules (e.g., specifying one or more of an assertion strictness, a maximum graph distance, or traversable edge types). In some implementations, based on calculated traversal distances between the linked response entity and each of one or more ground truth entities of the ground truth text, the ontological distance calculator 334 selects a minimum of the calculated traversal distances for the response entity:

$${D}_{min} = min ( {D}_{1} , {D}_{2} , ... , {D}_{k ,} {D}_{max ,} ) , \qquad ( 2 )$$

where Dₖ denotes the kth linked ground truth entity of a set of k linked ground truth entities of the ground truth text for which a traversal distance to the linked response entity is calculated and Dₘₐₓ, denotes the maximum graph distance specified in the rules. For example, if no traversal distances that satisfy the rules are obtainable for the linked response entity, the ontological distance calculator 334 assigns the specified maximum graph distance to the linked response entity as the selected traversal distance. Accordingly, for each of the ground truth texts, the ontology entity determines a set of traversal distances including a minimal traversal score (Dₘᵢₙ) for each of the linked response entities. In some implementations, instead of the minimum traversal score, a traversal score meeting another specified condition (e.g., being within a standard deviation of the minimum traversal score or other condition) may be used.

The ground truth text scorer 338 determines a ground truth text score (e.g., ground truth text score 340) for each ground truth text of the multiple ground truth texts (e.g., ground truth text 308) based on the set of traversal distances (e.g., set of Dₘᵢₙs) determined for the ground truth text by the ontological distance calculator 334. The ground truth text score (e.g., ground truth text score 340) for a particular ground truth text (e.g., ground truth text 308) of the multiple ground truth texts may be calculated as follows:

$${S}_{GT} = {\sum }_{i = 1}^{n} {D}_{{min}_{i}} , \qquad ( 3 )$$

where S_{GT} denotes a ground truth text score (e.g., ground truth text score 340), n denotes the number of linked entities in the linked response entities, I denotes the ith linked entity of the linked response entities, and Dₘᵢₙ_{ᵢ} denotes the minimal traversal distance determined for the ith linked entity of the linked response entities determined according to Equation (2).

In some implementations, the normalized ground truth score, S′_{GT}, for a ground truth text can be calculated as follows:

$${S}_{GT}^{′} = \frac{{\sum }_{i = 1}^{n} {D}_{{min}_{i}}}{n} , \qquad ( 4 )$$

which is obtained by dividing the ground truth text score S_{GT} by the number of linked entities n in the linked response entities. The model output evaluator 310 may use the ground truth text scores (e.g., ground truth text score) as a basis for classifying the language model output text 306.

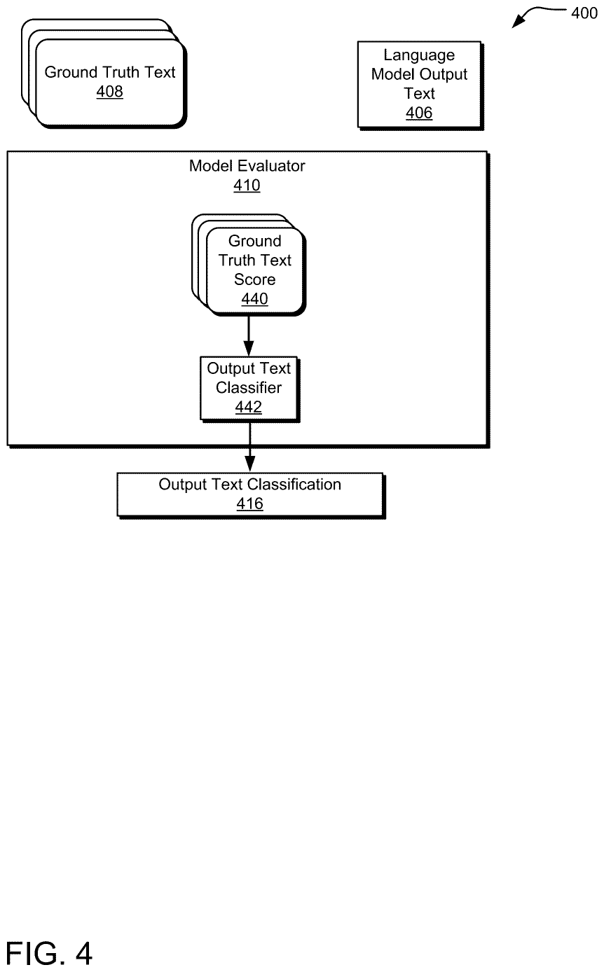

FIG. 4 illustrates an example computing environment 400 for determining, by a model output evaluator 410, a classification of an output text of a language model based on ground truth text scores determined for multiple ground truth texts. The example computing environment 400 includes a model output evaluator 410.

The model output evaluator 410 includes an output text classifier 442. The output text classifier 442 may determine an output text classification for a language model output text 406 based on whether at least one of a set of ground truth text scores (e.g., determined according to Equations (3)-(4)) satisfies a predefined condition. For example, each of the ground truth text scores (e.g., ground truth text score 440) is associated with a corresponding ground truth text (e.g., ground truth text 408).

For example, the output text classifier 442 determines or otherwise accesses a ground truth text score for each of the ground truth texts of the multiple ground truth texts, selects the lowest ground truth text score (e.g., indicating a ground truth text having a lowest sum of traversal distances corresponding to the linked response entities) as an output score. The selection of the output score may be represented by the following expression:

$$output score = min ( {S}_{{GT}_{1}}^{′} , {S}_{{GT}_{2}}^{′} , ... , {S}_{{GT}_{u}}^{′} ) , \qquad ( 5 )$$

where u denotes the number of ground truth texts for which a ground truth text score was determined, where S′_{GT}_{ᵤ} denotes the normalized ground truth text score for the uth ground truth text. The output text classifier 442 classifies the language model output text based on comparing the output score (e.g., determined using Equation (5)) to a classification criterion. The classification criterion may specify that the output score meets a condition of comparison (e.g., less than) to a predefined threshold output score. In some implementations, if the output text score (e.g., a lowest ground truth text score corresponding to at least one of the ground truth texts) satisfies the classification criterion, the output text classifier 442 assigns a “pass” output text classification to the language model output text 406 and, if the output text score does not satisfy the classification criterion, the output text classifier 442 assigns a “fail” output text classification to the language model output text 406.

In some implementations, the output text classification 416 may advise a user of the language model. For example, the output text classification 416 may be displayed in a user interface along with the language model output text 406 to advise the user that the language model output text 406 is either reliable (e.g., a “pass” classification) or not reliable (e.g., a “fail” classification). In some implementations, the output text classification 416 may be determined for each of a set of inputs to the language model that was used to generate a set of language model output texts and then one or more inputs having an output text classification 416 that satisfies the classification criterion are selected as best inputs to the language model. In some implementations, the output text classification 416 is used to modify one or more parameters (e.g., weights, etc.) of the language model.

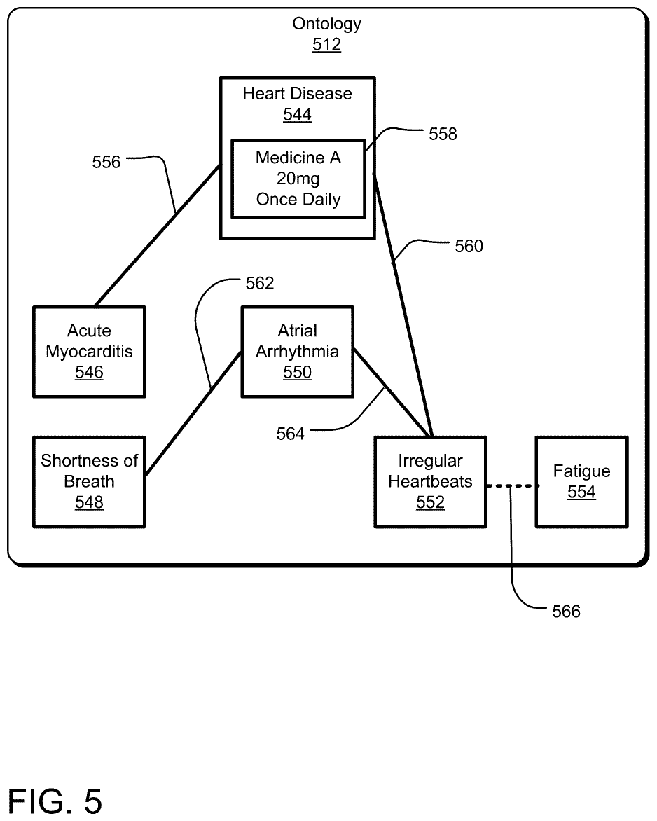

FIG. 5 illustrates a portio of an ontology 512. The ontology 512 is represented using a graph structure. The nodes in the depicted portion of the ontology 512 represent concepts including heart disease 544, acute myocarditis 546, shortness of breath 548, atrial arrhythmia 550, irregular heartbeats 552, and fatigue 554. The nodes are connected via edges (e.g., edge 556, edge 560, edge 562, edge 564, edge 566). Each of the concepts of the ontology 512 may include object properties that define relationships of the concept with other concepts. In the portion of the ontology 512 depicted in FIG. 5, the object properties of the concepts include a class (e.g., a category such as “disease”) to instance (e.g., a symptom of the disease) relationship, which is depicted in FIG. 5 using a top-down relationship. For example, the heart disease 544 node is connected via edge 560 to the irregular heartbeats 552 node below, indicating that irregular heartbeats 552 is an instance of the class of heart disease 544. For example, irregular heartbeats 552 and shortness of breath 548 are both instances (e.g., symptoms of) the class (e.g., diagnosis) of atrial arrhythmia 550. The dashed line of the edge 566 represents a relationship of co-occurrence. For example, co-occurrence indicates that fatigue 554 symptoms are likely to occur at the same time (or in the same patient) as a symptom of irregular heartbeats 552. In some implementations, the co-occurrence relationship is not represented in the ontology itself. Instead, a co-occurrence database is accessed, and a set of concepts of the ontology co-occurring with the concept corresponding to the entity is extracted. Although not illustrated in FIG. 5, the fatigue 554 concept node may be connected to one or more additional nodes that are not depicted in FIG. 5 via one or more single arrow edges (e.g., that depict a relationship of class to instance) that are not depicted in FIG. 5.

Each of the concepts of the ontology 512 (e.g., heart disease 544, acute myocarditis 546, shortness of breath 548, atrial arrhythmia 550, irregular heartbeats 552, and fatigue 554) may include data properties (e.g., data property 558), for example, a Unified Medical Language System (UMLS) code representing the concept, a text description describing the concept, a treatment regimen, or other data properties. For example, data properties of certain concepts may include suggested medications and dosage guidelines for treatment or management of the disease indicated by the concept. For example, data property 558 associated with the heart disease 544 concept node represents a treatment regimen of “Medicine A, 20 mg.” The ontology 512 is one example of an ontology and the concepts and their relationships may be mapped differently than the mapping provided in the example ontology 512. For example, a medication (with a dosage) may be represented by an instance node, connected to a category node by the edge “X cures Y”. For example, a Heart Disease concept may be connected to a “Medicine A 20 milligram” concept by “X cures Y” connection and, therefore, the “Medicine A 20 milligram” concept will be a concept hierarchically under the “medicine A” concept. Further, the example ontology 512 is in a medical knowledge domain, but ontologies in other knowledge domains (e.g., criminal law, civil law, journalism, chemistry, etc.) may be used, as appropriate.

The graph structure of the example ontology 512 depicted in FIG. 5 is one example of a data structure that can be used to represent the ontology 512. In some implementations, the ontology 512 may also be represented using a hierarchical tree structure, a table, a taxonomy, or other data structures.

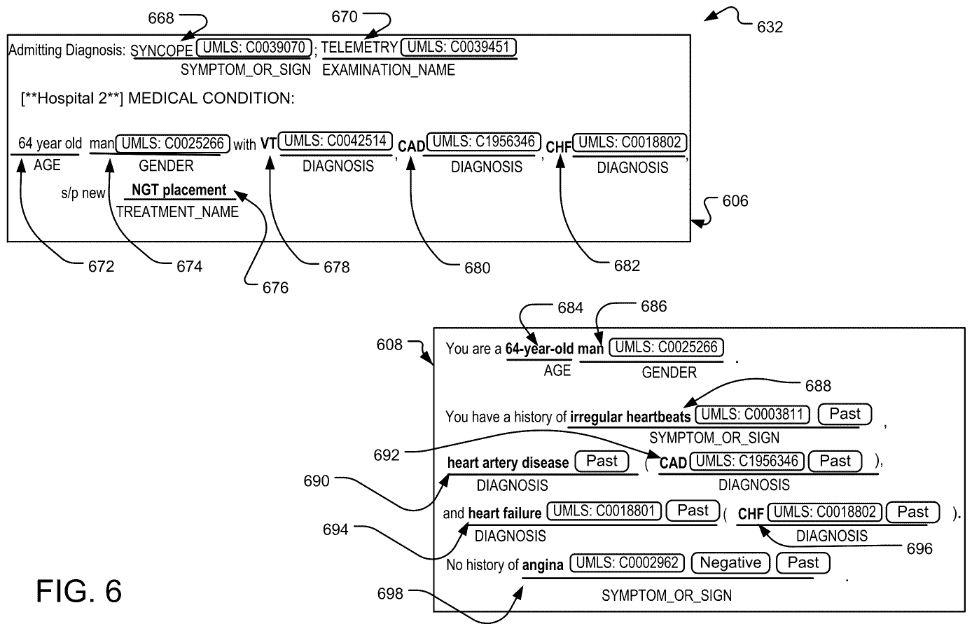

FIG. 6 illustrates an ontology-entity mapping 632 including linked response entities of a language model output text 606 and linked ground truth entities 226 of a ground truth text 608 mapped to ontology entities of an ontology. The example, ontology-entity mapping 632 associates ontology entities of a medical ontology identified with UMLS codes with entities identified in each of the language model output text 606 and the ground truth text 608.

For example, entities of the language model output text 606 are detected (e.g., using an NER algorithm) and include response entity 668 (“Syncope”), response entity 670 (“Telemetry”), response entity 672 (“64-year-old”) response entity 674 (“man”), response entity 676 (“NGT placement”), response entity 678 (“VT”), response entity 680 (“CAD”), and response entity 682 (“CHF”). For example, the raw text of the language model output text 606 may read “Admitting Diagnosis: SYNCOPE; TELEMETRY [**Hospital 2**] MEDICAL CONDITION: 64-year-old man with VT, CAD, CHF s/p new NGT placement.” In some implementations, as depicted in FIG. 6, the type of each response entity (e.g., “symptom_or_sign,” “examination_name,” “age,” “gender,” “treatment_name,” “diagnosis,”) is also determined (e.g., using the NER algorithm) and associated with the detected response entities, respectively. As depicted in FIG. 6, a subset of the response entities detected in the language model output text 606 are linked response entities that are linked to corresponding ontology entities of a medical ontology using UMLS codes (e.g., response entity 668 linked to UMLS: C0039080, response entity 670 linked to UMLS: C0039451, response entity 674 linked to UMLS: C0025266, response entity 678 linked to UMLS: C0042514, response entity 680 linked to UMLS: C1956346, and response entity 682 linked to UMLS: C0018802).

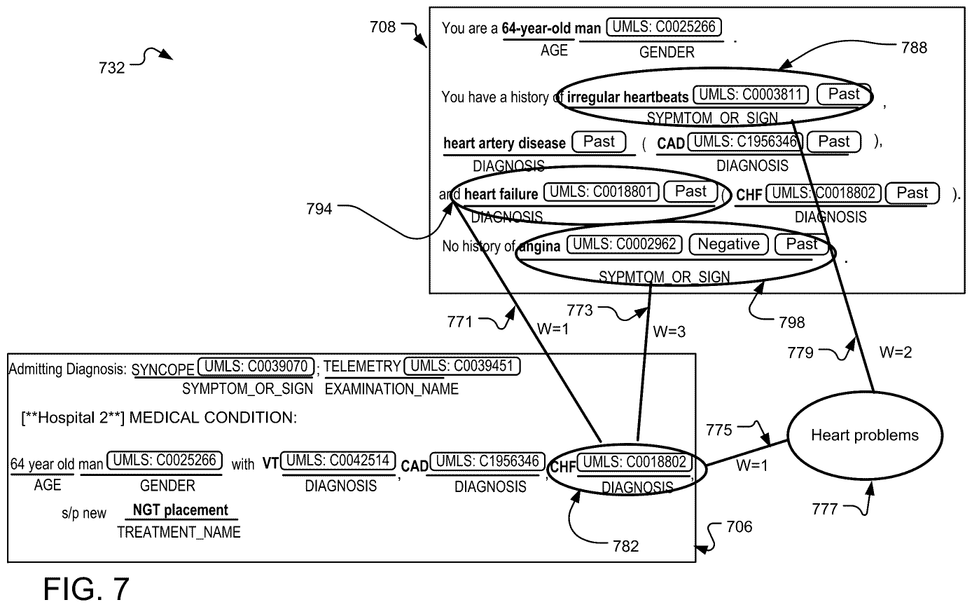

Likewise, entities of the ground truth text 608 are detected (e.g., using an NER algorithm) and include ground truth entity 684 (“64-year-old”), ground truth entity 686 (“man”), ground truth entity 688 (“irregular heartbeats”) ground truth entity 690 (“heart artery disease”), ground truth entity 692 (“CAD”), ground truth entity 694 (“heart failure”), ground truth entity 696 (“CHF”), and ground truth entity 698 (“angina”). For example, the raw text of the ground truth text 608 may read “You are a 64-year-old man. You have a history of irregular heartbeats, heart artery disease (CAD) and heart failure (CHR). No history of angina.” In some implementations, as depicted in FIG. 6, the type of each ground truth entity (e.g., “age,” “gender,” “symptom_or_sign,” “diagnosis,” “diagnosis,” “diagnosis,” “diagnosis,” and “symptom_or_sign”) is also determined (e.g., using the NER algorithm) and associated with the detected ground truth entities, respectively. As depicted in FIG. 6, a subset of the entities detected in the ground truth text 608 are linked ground truth entities that are linked to corresponding ontology entities of the medical ontology using UMLS codes (e.g., ground truth entity 686 linked to UMLS: C1956346, ground truth entity 694 linked to UMLS: C0018801, ground truth entity 696 linked to UMLS: C0018802, and ground truth entity 698 linked to UMLS: C0002962). FIG. 7 illustrates a process for determining a traversal distance for a linked to response entity 782 of a language model output text 706 using an ontology-entity mapping 732 for use in determining a ground truth text score 708. For example, FIG. 7 depicts the example ontology-entity mapping of FIG. 6 and further depicts a graph structure of a portion of an ontology including nodes (depicted as ovals) corresponding to linked response entity 782, linked ground truth entity 788, linked ground truth entity 794, and linked ground truth entity 798, and edges (depicted as lines between ovals) between the nodes including edge 771, edge 773, edge 775, and edge 779. The graph structure of the portion of the ontology also includes a node 777 to which no ground truth entities or response entities are linked. Each of the edges of the graph structure of the portion of the ontology depicted in FIG. 7 includes an associated weight (e.g., W=1 corresponding to edge 771, W=3 corresponding to edge 773, W=1 corresponding to edge 775, and W=2 corresponding to edge 779). Using the graph structure, traversal distances (e.g., D₁, D₂, . . . , Dₖ) may be determined for the linked response entity 782, for example, using Equation (1). For example, a first traversal distance between linked response entity 782 and linked ground truth entity 794 is calculated by adding the weight (W=1) of traversed edge 771 to yield a first traversal distance (D₁) of one (1). A second traversal distance between linked response entity 782 and linked ground truth entity 798 is calculated by adding the weight (W=3) of traversed edge 773 to yield a second traversal distance (D₂) of three (3). A third traversal distance between linked response entity 782 and linked ground truth entity 788 is calculated by adding the weight (W=1) of traversed edge 775 and the weight (W=2) of traversed edge 779 to yield a third traversal distance (D₃) of three (3). Having determined the traversal distances D₁=1, D₂=3, and D₃=3, a minimal traversal distance Dₘᵢₙ, for the linked response entity 782 may be determined using Equation (2), yielding Dₘᵢₙ=1.

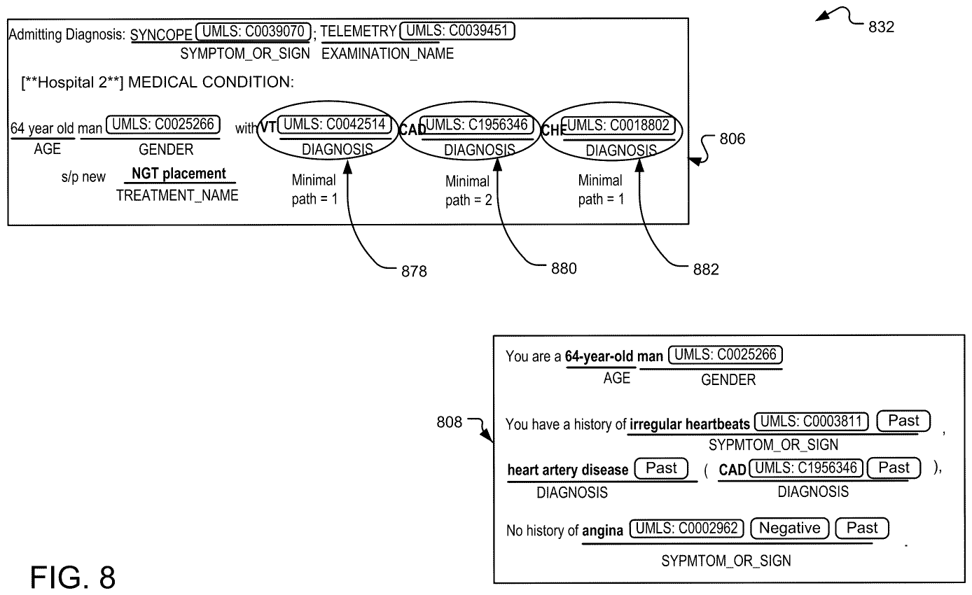

FIG. 8 illustrates example minimal traversal distances calculated for three response entities of a language model output text 706 using an ontology-entity mapping 732 for use in determining a ground truth text score 708. For example, FIG. 8 depicts the example ontology-entity mapping 832. The ontology-entity mapping 832 corresponds to the ontology-entity mapping of FIG. 6, and depicts minimal traversal distances (depicted as “Minimal path”) of linked response entity 878, linked response entity 880, and linked response entity 882 of language model output text 806. For example, the minimal traversal distance (e.g., Dₘᵢₙ of Equation (2)) of linked response entity 882 (“Minimal path=1”) was determined using the example process illustrated in FIG. 7. In a like manner, the minimal traversal distance (“Minimal path=1”) of the linked response entity 878 and the minimal traversal distance (“Minimal path=2”) of the linked response entity 880 may be determined. After a minimal traversal distance is obtained for the linked response entities, a ground truth score for the ground truth text 808 may be determined by summing the minimal traversal distances (e.g., 1+2+3=6) using Equation (3).

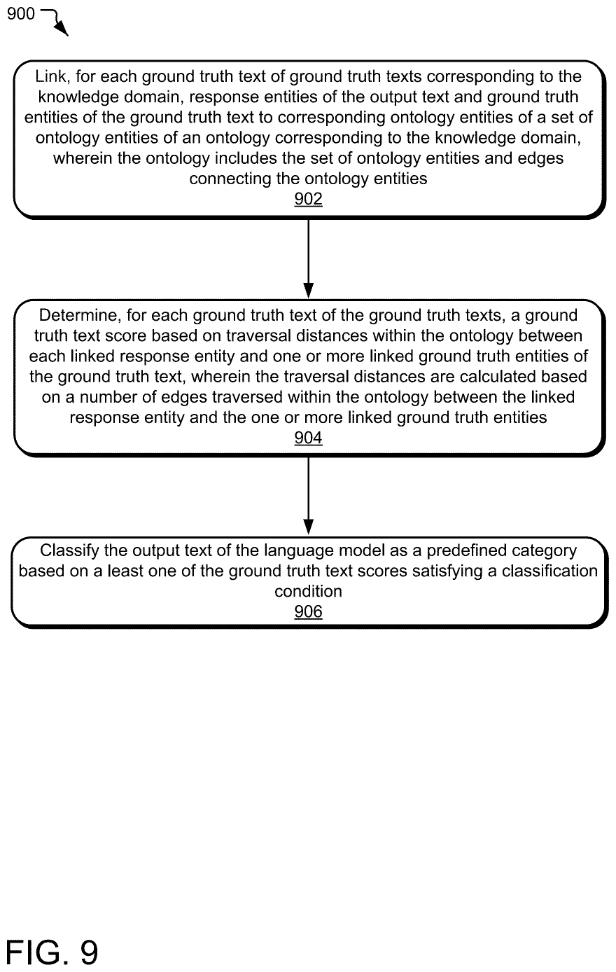

FIG. 9 depicts example operations 900 for classifying an output text of a language model corresponding to a knowledge domain. The example operations 900 are, in some implementations, performed by a model output evaluator with characteristics the same or similar as the model output corrupters described herein with respect to FIG. 1-4.

An example linking operation 902 links, for each ground truth text of ground truth texts corresponding to the knowledge domain, response entities of the output text and ground truth entities of the ground truth text to corresponding ontology entities of a set of ontology entities of an ontology corresponding to the knowledge domain, wherein the ontology includes the set of ontology entities and edges connecting the ontology entities.

An example determining operation 904 determines, for each ground truth text of the ground truth texts, a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities. In some implementations, determining the ground truth text score for each ground truth text of the ground truth texts further comprises determining for each linked response entity from the traversal distances, a minimum traversal distance and summing the minimum traversal distances to determine the ground truth text score. In some implementations, the at least one of the ground truth text scores is a lowest ground truth text score. In some implementations, the ontology includes weights corresponding to the edges, and the traversal distances are further calculated based on the weights of the edges traversed within the ontology between the linked response entity and the one or more linked ground truth entities.

In some implementations, the traversal distances within the ontology between each linked response entity and the one or more linked ground truth entities of the ground truth text are calculated over traversal paths within the ontology that include traversable edges and that do not include non-traversable edges. In these implementations, the traversable edges represent a first type of relationship between entities of the ontology, and the non-traversable edges represent a second type of relationship between the entities of the ontology. In some implementations, the traversal distances within the ontology between each linked response entity and the one or more linked ground truth entities of the ground truth text exclude traversal distances are greater than a threshold traversal distance. In some implementations, the one or more linked ground truth entities of the ground truth text for which the traversal distances from the linked response entity are calculated satisfy an assertion criterion with the linked response entity.

An example classifying operation 906 classifies the output text of the language model as a predefined category based on a least one of the ground truth text scores satisfying a classification condition.

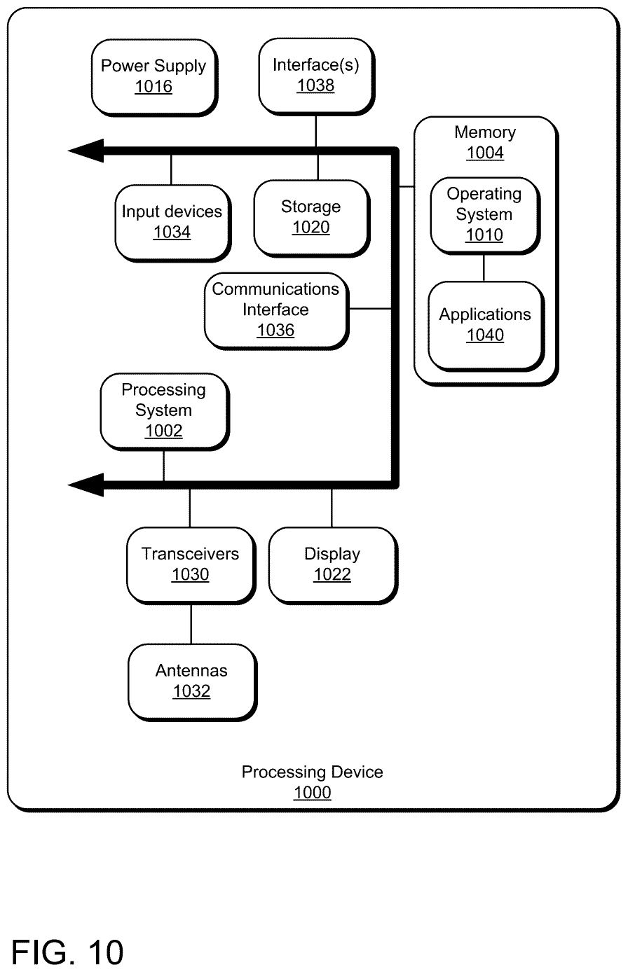

FIG. 10 illustrates an example computing device 1000 for use in implementing the described technology. The computing device 1000 may be a client computing device (such as a laptop computer, a desktop computer, or a tablet computer), a server/cloud computing device, an Internet-of-Things (IoT), any other type of computing device, or a combination of these options. The computing device 1000 includes one or more hardware processor(s) 1002 and a memory 1004. The memory 1004 generally includes both volatile memory (e.g., RAM) and nonvolatile memory (e.g., flash memory), although one or the other type of memory may be omitted. An operating system 1010 resides in the memory 1004 and is executed by the processor(s) 1002. In some implementations, the computing device 1000 includes and/or is communicatively coupled to storage 1020.

In the example computing device 1000, as shown in FIG. 10, one or more software modules, segments, and/or processors, such as applications 1040, a model output evaluator, a language model, a large language model (LLM), an entity extractor, an entity-ontology linker, an ontological distance calculator, a ground truth text scorer, an output text classifier, and other program code and modules are loaded into the operating system 1010 on the memory 1004 and/or the storage 1020 and executed by the processor(s) 1002. The storage 1020 may store language model output data, ground truth texts, rules (e.g., rules for determining traversal distance, for example, assertion strictness, definitions of traversable and non-traversable edges, and a maximum graph distance), one or more ontologies, edge weights, calculated traversal distances, ground truth text scores, output scores, and other data and be local to the computing device 1000 or may be remote and communicatively connected to the computing device 1000. In particular, in one implementation, components of a system for generating corrupted output data from output data may be implemented entirely in hardware or in a combination of hardware circuitry and software.

The computing device 1000 includes a power supply 1016, which may include or be connected to one or more batteries or other power sources and which provides power to other components of the computing device 1000. The power supply 1016 may also be connected to an external power source that overrides or recharges the built-in batteries or other power sources.

The computing device 1000 may include one or more communication transceivers 1030, which may be connected to one or more antenna(s) 1032 to provide network connectivity (e.g., mobile phone network, Wi-Fi®, Bluetooth®) to one or more other servers, client devices, IoT devices, and other computing and communications devices. The computing device 1000 may further include a communications interface 1036 (such as a network adapter or an I/O port, which are types of communication devices). The computing device 1000 may use the adapter and any other types of communication devices for establishing connections over a wide-area network (WAN) or local-area network (LAN). It should be appreciated that the network connections shown are exemplary and that other communications devices and means for establishing a communications link between the computing device 1000 and other devices may be used.

The computing device 1000 may include one or more input devices 1034 such that a user may enter commands and information (e.g., a keyboard, trackpad, or mouse). These and other input devices may be coupled to the server by one or more interfaces 1038, such as a serial port interface, parallel port, or universal serial bus (USB). The computing device 1000 may further include a display 1022, such as a touchscreen display.

The computing device 1000 may include a variety of tangible processor-readable storage media and intangible processor-readable communication signals. Tangible processor-readable storage can be embodied by any available media that can be accessed by the computing device 1000 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 1000. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of classifying an output text of a language model corresponding to a knowledge domain, comprising: for each ground truth text of ground truth texts corresponding to the knowledge domain, linking response entities of the output text and ground truth entities of the ground truth text to corresponding ontology entities of a set of ontology entities of an ontology corresponding to the knowledge domain, wherein the ontology includes the set of ontology entities and edges connecting the ontology entities; for each ground truth text of the ground truth texts, determining a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and classifying the output text of the language model as a predefined category based on at least one ground truth text score of the ground truth text scores satisfying a classification condition.

Clause 2. The method of clause 1, wherein determining the ground truth text score for each ground truth text of the ground truth texts further comprises: for each linked response entity, selecting, from the traversal distances, a traversal distance satisfying a condition; and summing the selected traversal distances to determine the ground truth text score.

Clause 3. The method of clause 1, wherein the at least one ground truth text score includes a lowest ground truth text score.

Clause 4. The method of clause 1, wherein the ontology includes weights corresponding to the edges, wherein the traversal distances are further calculated based on the weights of the edges traversed within the ontology between the linked response entity and the one or more linked ground truth entities.

Clause 5. The method of clause 1, wherein the traversal distances within the ontology between each linked response entity and the one or more linked ground truth entities of the ground truth text are calculated over traversal paths within the ontology that include traversable edges and that do not include non-traversable edges, wherein the traversable edges represent a first relationship type between entities of the ontology, wherein the non-traversable edges represent a second relationship type between the entities of the ontology.

Clause 6. The method of clause 1, wherein the traversal distances within the ontology between each linked response entity and the one or more linked ground truth entities of the ground truth text are less than or equal to a threshold traversal distance.

Clause 7. The method of clause 1, wherein the one or more linked ground truth entities of the ground truth text for which the traversal distances from the linked response entity are calculated satisfy an assertion criterion with the linked response entity.

Clause 8. A system for classifying an output text of a language model corresponding to a knowledge domain, comprising: one or more hardware processors; a memory; a entity-ontology linker storable in the memory, executable by the one or more hardware processors, and configured to perform operations comprising linking, for each ground truth text of ground truth texts corresponding to the knowledge domain, response entities of the output text and ground truth entities of the ground truth text to corresponding ontology entities of a set of ontology entities of an ontology corresponding to the knowledge domain, wherein the ontology includes the set of ontology entities and edges connecting the ontology entities; a ground truth text scorer storable in the memory, executable by the one or more hardware processors and configured to perform operations comprising determining, for each ground truth text of the ground truth texts, a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and an output text classifier storable in the memory, executable by the one or more hardware processors, and configured to perform operations comprising classifying the output text of the language model as a predefined category based on at least one ground truth text score of the ground truth text scores satisfying a classification condition.

Clause 9. The system of clause 8, wherein the ground truth text scorer is further configured to select a traversal distance from the traversal distances of each linked response entity that satisfies a condition and to sum the selected traversal distances to determine the ground truth text score.

Clause 10. The system of clause 8, wherein the at least one ground truth text score includes a lowest ground truth text score.

Clause 11. The system of clause 8, wherein the ontology includes weights corresponding to the edges, and further comprising an ontological distance calculator storable in the memory and executable by the one or more hardware processors and configured to perform operations comprising calculating the traversal distances, wherein the traversal distances are further calculated based on the weights of the edges traversed within the ontology between the linked response entity and the one or more linked ground truth entities.

Clause 12. The system of clause 8, further comprising an ontological distance calculator storable in the memory and executable by the one or more hardware processors and configured to perform operations comprising calculating the traversal distances within the ontology between each linked response entity and the one or more linked ground truth entities of the ground truth text over traversal paths within the ontology that include traversable edges and that do not include non-traversable edges, wherein the traversable edges represent a first relationship type between entities of the ontology, wherein the non-traversable edges represent a second relationship type between the entities of the ontology.

Clause 13. The system of clause 8, wherein the traversal distances within the ontology between each linked response entity and the one or more linked ground truth entities of the ground truth text are less than or equal to a threshold traversal distance.

Clause 14. The system of clause 8, wherein the one or more linked ground truth entities of the ground truth text for which the traversal distances from the linked response entity are calculated satisfy an assertion criterion with the linked response entity.

Clause 15. One or more tangible processor-readable storage media embodied with instructions for executing on one or more processors and circuits of a computing device a process for classifying an output text of a language model corresponding to a knowledge domain, the process comprising: for each ground truth text of ground truth texts corresponding to the knowledge domain, linking response entities of the output text and ground truth entities of the ground truth text to corresponding ontology entities of a set of ontology entities of an ontology corresponding to the knowledge domain, wherein the ontology includes the set of ontology entities and edges connecting the ontology entities; for each ground truth text of the ground truth texts, determining a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and classifying the output text of the language model as a predefined category based on a least one ground truth text score of the ground truth text scores satisfying a classification condition.

Clause 16. The one or more tangible processor-readable storage media of clause 15, wherein determining the ground truth text score for each ground truth text of the ground truth texts further comprises: for each linked response entity, selecting, from the traversal distances, a traversal distance satisfying a condition; and summing the selected traversal distances to determine the ground truth text score.

Clause 17. The one or more tangible processor-readable storage media of clause 15, wherein the ontology includes weights corresponding to the edges, wherein the traversal distances are further calculated based on the weights of the edges traversed within the ontology between the linked response entity and the one or more linked ground truth entities.

Clause 18. The one or more tangible processor-readable storage media of clause 15, wherein the traversal distances within the ontology between each linked response entity and the one or more linked ground truth entities of the ground truth text are calculated over traversal paths within the ontology that include traversable edges and that do not include non-traversable edges, wherein the traversable edges represent a first relationship type between entities of the ontology, wherein the non-traversable edges represent a second relationship type between the entities of the ontology.

Clause 19. The one or more tangible processor-readable storage media of clause 15, wherein the traversal distances within the ontology between each linked response entity and the one or more linked ground truth entities of the ground truth text are less than or equal to a threshold traversal distance.

Clause 20. The one or more tangible processor-readable storage media of clause 15, wherein the one or more linked ground truth entities of the ground truth text for which the traversal distances from the linked response entity are calculated satisfy an assertion criterion with the linked response entity.

Clause 21. A system of classifying an output text of a language model corresponding to a knowledge domain, comprising: means for linking, for each ground truth text of ground truth texts corresponding to the knowledge domain, response entities of the output text and ground truth entities of the ground truth text to corresponding ontology entities of a set of ontology entities of an ontology corresponding to the knowledge domain, wherein the ontology includes the set of ontology entities and edges connecting the ontology entities; means for determining, for each ground truth text of the ground truth texts, a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and means for classifying the output text of the language model as a predefined category based on at least one ground truth text score of the ground truth text scores satisfying a classification condition.

Clause 22. The system of clause 21, wherein the means for determining the ground truth text score for each ground truth text of the ground truth texts further comprises: means for selecting, for each linked response entity from the traversal distances, a traversal distance satisfying a condition; and summing the selected traversal distances to determine the ground truth text score.

Clause 23. The system of clause 21, wherein the at least one ground truth text score includes a lowest ground truth text score.

Clause 24. The system of clause 21, wherein the ontology includes weights corresponding to the edges, wherein the traversal distances are further calculated based on the weights of the edges traversed within the ontology between the linked response entity and the one or more linked ground truth entities.

Clause 25. The system of clause 21, wherein the traversal distances within the ontology between each linked response entity and the one or more linked ground truth entities of the ground truth text are calculated over traversal paths within the ontology that include traversable edges and that do not include non-traversable edges, wherein the traversable edges represent a first relationship type between entities of the ontology, wherein the non-traversable edges represent a second relationship type between the entities of the ontology.

Clause 26. The system of clause 21, wherein the traversal distances within the ontology between each linked response entity and the one or more linked ground truth entities of the ground truth text are less than or equal to a threshold traversal distance.

Clause 27. The system of clause 21, wherein the one or more linked ground truth entities of the ground truth text for which the traversal distances from the linked response entity are calculated satisfy an assertion criterion with the linked response entity.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of classifying an output text of a language model corresponding to a knowledge domain, comprising:
for each ground truth text of ground truth texts corresponding to the knowledge domain, linking response entities of the output text and ground truth entities of the ground truth text to corresponding ontology entities of a set of ontology entities of an ontology corresponding to the knowledge domain, wherein the ontology includes the set of ontology entities and edges connecting the ontology entities;
for each ground truth text of the ground truth texts, determining a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and
classifying the output text of the language model as a predefined category based on at least one ground truth text score of the ground truth text scores satisfying a classification condition.

2. The method of claim 1, wherein determining the ground truth text score for each ground truth text of the ground truth texts further comprises:
for each linked response entity, selecting, from the traversal distances, a traversal distance satisfying a condition; and
summing the selected traversal distances to determine the ground truth text score.

3. The method of claim 1, wherein the at least one ground truth text score includes a lowest ground truth text score.

4. The method of claim 1, wherein the ontology includes weights corresponding to the edges, wherein the traversal distances are further calculated based on the weights of the edges traversed within the ontology between the linked response entity and the one or more linked ground truth entities.

5. The method of claim 1, wherein the traversal distances within the ontology between each linked response entity and the one or more linked ground truth entities of the ground truth text are calculated over traversal paths within the ontology that include traversable edges and that do not include non-traversable edges, wherein the traversable edges represent a first relationship type between entities of the ontology, wherein the non-traversable edges represent a second relationship type between the entities of the ontology.

6. The method of claim 1, wherein the traversal distances within the ontology between each linked response entity and the one or more linked ground truth entities of the ground truth text are less than or equal to a threshold traversal distance.

7. The method of claim 1, wherein the one or more linked ground truth entities of the ground truth text for which the traversal distances from the linked response entity are calculated satisfy an assertion criterion with the linked response entity.

8. A system for classifying an output text of a language model corresponding to a knowledge domain, comprising:
one or more hardware processors;
a memory;
a entity-ontology linker storable in the memory, executable by the one or more hardware processors, and configured to perform operations comprising linking, for each ground truth text of ground truth texts corresponding to the knowledge domain, response entities of the output text and ground truth entities of the ground truth text to corresponding ontology entities of a set of ontology entities of an ontology corresponding to the knowledge domain, wherein the ontology includes the set of ontology entities and edges connecting the ontology entities;
a ground truth text scorer storable in the memory, executable by the one or more hardware processors and configured to perform operations comprising determining, for each ground truth text of the ground truth texts, a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and
an output text classifier storable in the memory, executable by the one or more hardware processors, and configured to perform operations comprising classifying the output text of the language model as a predefined category based on at least one ground truth text score of the ground truth text scores satisfying a classification condition.

9. The system of claim 8, wherein the ground truth text scorer is further configured to select a traversal distance from the traversal distances of each linked response entity that satisfies a condition and to sum the selected traversal distances to determine the ground truth text score.

10. The system of claim 8, wherein the at least one ground truth text score includes a lowest ground truth text score.

11. The system of claim 8, wherein the ontology includes weights corresponding to the edges, and further comprising an ontological distance calculator storable in the memory and executable by the one or more hardware processors and configured to perform operations comprising calculating the traversal distances, wherein the traversal distances are further calculated based on the weights of the edges traversed within the ontology between the linked response entity and the one or more linked ground truth entities.

12. The system of claim 8, further comprising an ontological distance calculator storable in the memory and executable by the one or more hardware processors and configured to perform operations comprising calculating the traversal distances within the ontology between each linked response entity and the one or more linked ground truth entities of the ground truth text over traversal paths within the ontology that include traversable edges and that do not include non-traversable edges, wherein the traversable edges represent a first relationship type between entities of the ontology, wherein the non-traversable edges represent a second relationship type between the entities of the ontology.

13. The system of claim 8, wherein the traversal distances within the ontology between each linked response entity and the one or more linked ground truth entities of the ground truth text are less than or equal to a threshold traversal distance.

14. The system of claim 8, wherein the one or more linked ground truth entities of the ground truth text for which the traversal distances from the linked response entity are calculated satisfy an assertion criterion with the linked response entity.

15. One or more tangible processor-readable storage media embodied with instructions for executing on one or more processors and circuits of a computing device a process for classifying an output text of a language model corresponding to a knowledge domain, the process comprising:
for each ground truth text of ground truth texts corresponding to the knowledge domain, linking response entities of the output text and ground truth entities of the ground truth text to corresponding ontology entities of a set of ontology entities of an ontology corresponding to the knowledge domain, wherein the ontology includes the set of ontology entities and edges connecting the ontology entities;
for each ground truth text of the ground truth texts, determining a ground truth text score based on traversal distances within the ontology between each linked response entity and one or more linked ground truth entities of the ground truth text, wherein the traversal distances are calculated based on a number of edges traversed within the ontology between the linked response entity and the one or more linked ground truth entities; and
classifying the output text of the language model as a predefined category based on a least one ground truth text score of the ground truth text scores satisfying a classification condition.

16. The one or more tangible processor-readable storage media of claim 15, wherein determining the ground truth text score for each ground truth text of the ground truth texts further comprises:
for each linked response entity, selecting, from the traversal distances, a traversal distance satisfying a condition; and
summing the selected traversal distances to determine the ground truth text score.

17. The one or more tangible processor-readable storage media of claim 15, wherein the ontology includes weights corresponding to the edges, wherein the traversal distances are further calculated based on the weights of the edges traversed within the ontology between the linked response entity and the one or more linked ground truth entities.

18. The one or more tangible processor-readable storage media of claim 15, wherein the traversal distances within the ontology between each linked response entity and the one or more linked ground truth entities of the ground truth text are calculated over traversal paths within the ontology that include traversable edges and that do not include non-traversable edges, wherein the traversable edges represent a first relationship type between entities of the ontology, wherein the non-traversable edges represent a second relationship type between the entities of the ontology.

19. The one or more tangible processor-readable storage media of claim 15, wherein the traversal distances within the ontology between each linked response entity and the one or more linked ground truth entities of the ground truth text are less than or equal to a threshold traversal distance.

20. The one or more tangible processor-readable storage media of claim 15, wherein the one or more linked ground truth entities of the ground truth text for which the traversal distances from the linked response entity are calculated satisfy an assertion criterion with the linked response entity.
